(19) United States
(12) Patent Application Publication
(10) Pub. No.: US 2018/0112829 A1
(43) Pub. Date: Apr. 26, 2018

(54) CRYOGENIC FLUID SYSTEM FOR MACHINE, AND METHOD OF OPERATING SAME

(71) Applicant: Electro-Motive Diesel, Inc., LaGrange, IL (US)

(72) Inventor: Peter Popadiuc, Bensenville, IL (US)

(73) Assignee: Electro-Motive Diesel, Inc., LaGrange, IL (US)

(21) Appl. No.: 15/333,144

(22) Filed: Oct. 24, 2016

(51) Int. Cl. F17C 13/08; F17C 13/00

(52) U.S. Cl. CPC F17C 13/083; F17C 2227/0135; F17C 2225/0161; F17C 13/001

(57) ABSTRACT

A cryogenic fluid system such as a cryogenic fuel system for an engine includes a storage vessel, and a pumping mechanism with a pump positioned inside the storage vessel to be submerged in fluid stored therein. The system further includes a reciprocable pumping element operated by way of a drive mechanism including a rotatable driving element and a magnetic coupling operably between the rotatable driving element and the reciprocable pumping element.

### TECHNICAL FIELD

The present disclosure relates generally to pumping fluid from a cryogenic fluid storage vessel, and more particularly to driving a submerged piston pump in a cryogenic fluid system by way of a rotary magnetic coupling and a rotary to linear motion converter.

### BACKGROUND

Cryogenic fluid systems are used in a wide variety of applications, commonly where transport and handling of a material in a liquid state rather than a gaseous state is desired. In recent years, cryogenic fluid systems in the field of internal combustion engines have received increasing interest. Combustible hydrocarbon fuels such as liquefied natural gas (LNG), liquid propane (LP), and still others are known to provide certain advantages over traditional hydrocarbon fuels such as gasoline and diesel, notably with respect to emissions. Economics and resource availability are also factors driving increased attention to technology in this area.

In a typical design a vessel contains a liquefied fuel such as LNG, and is equipped with an apparatus such as a vaporizer or evaporator to transition the fuel from a liquid form to a gaseous form for supplying to cylinders in an engine for combustion. Various systems have been proposed that provide submerged or partially submerged pumps to convey the cryogenic liquid fuel from the storage vessel to the vaporizer equipment. Various challenges are attendant to operating pumps and the like inside of a closed cryogenic storage vessel, however. U.S. Pat. No. 6,129,529 relates to a submersible motor driven pump and drive coupling, with the pump being designed so that liquefied petroleum gas is passed through a motor assembly to cool and lubricate the motor assembly.

### SUMMARY OF THE INVENTION

In one aspect, a machine system includes a machine and a cryogenic fluid system including a cryogenic storage vessel, and a pumping mechanism structured to pump stored cryogenic fluid from the cryogenic storage vessel for supplying to the machine. The pumping mechanism includes a pump positioned inside the cryogenic storage vessel and having a pump housing, a reciprocable pumping element movable in a first direction to receive stored cryogenic fluid into the pump housing and in a second direction to discharge stored cryogenic fluid from the pump housing, and a drive mechanism for actuating the reciprocable pumping element. The drive mechanism includes a rotatable driving element positioned outside the cryogenic storage vessel, a rotatable driven element positioned inside the cryogenic storage vessel, and a magnetic coupling structured to transfer torque between the rotatable driving element and the rotatable driven element. The drive mechanism further includes a rotary to linear motion converter coupled between the rotatable driven element and the reciprocable pumping element to apply a linear force to the reciprocable pumping element in response to torque applied to the rotatable driven element by the magnetic coupling.

In another aspect, a cryogenic fluid system includes a pumping mechanism including a pump having a pump housing, a reciprocable pumping element movable in a first direction to receive stored cryogenic fluid into the pump housing and in a second direction to discharge stored cryogenic fluid from the pump housing, and a cryogenic storage vessel wall. The system further includes a drive mechanism including a rotatable driving element, a rotatable driven element, and a magnetic coupling structured to transfer torque between the rotatable driving element and the rotatable driven element. The magnetic coupling includes a first magnetic element fixed to rotate with the rotatable driving element and positioned upon an exterior side of the cryogenic storage vessel wall, and a second magnetic element fixed to rotate with the rotatable driven element and positioned upon an interior side of the cryogenic storage vessel wall. The drive mechanism further includes a rotary to linear motion converter coupled between the rotatable driving element and the reciprocable pumping element to apply a linear force to the reciprocable pumping element in response to torque applied to the rotatable driving element by the magnetic coupling.

In still another aspect, a method of operating a cryogenic fluid system includes rotating a driving element positioned outside a cryogenic fluid storage vessel, and transferring torque magnetically from the driving element to a driven element positioned inside the cryogenic fluid storage vessel. The method further includes converting torque of the driven element to linear force on a pumping element in a pump at least partially submerged in cryogenic fluid within the cryogenic storage vessel, and pumping the cryogenic fluid out of the cryogenic storage vessel at least in part by way of a reciprocation of the pumping element in response to the linear force.

### BRIEF DESCRIPTION OF THE DRAWINGS

FIG. 1 is a side diagrammatic view of a machine system, according to one embodiment;

FIG. 2 is a side diagrammatic view of a portion of a cryogenic fluid system, according to one embodiment;

FIG. 3 is a side diagrammatic view of a cryogenic fluid system, according to another embodiment; and

FIG. 4 is a side diagrammatic view of a cryogenic fluid system according to yet another embodiment.

### DETAILED DESCRIPTION

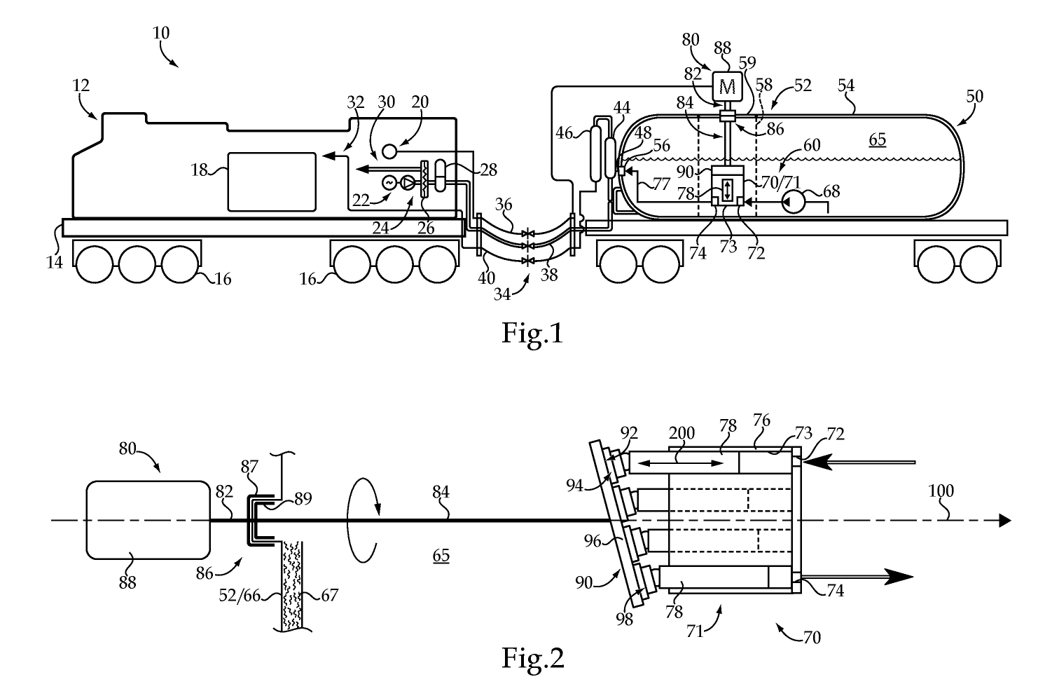

Referring to FIG. 1, there is shown a machine system 10 according to one embodiment, and including a machine 12 having a frame 14 supported by a plurality of rolling elements 16, at least some of which can be traction elements structured for applying traction power to a ground surface or rails. In a practical implementation strategy, machine 12 includes a locomotive, however, the present disclosure is not limited to locomotive or rail applications, or to a mobile machine or machine system at all, for reasons which will be further apparent from the following description. Machine 12 may include a combustion engine 18 such as a gaseous fuel internal combustion engine operated by way of diesel pilot ignition, although the present disclosure is not thereby limited. Engine 18 might be part of a genset, such that operation of engine 18 provides rotational power for rotating parts in a generator (not shown) that is part of or coupled with an electrical system 20 of machine system 10. A generator operated in this manner could be coupled with traction motors structured to drive rolling elements 16, in a generally conventional manner. Engine 18 could also be operated to directly drive rolling elements 16 by way of suitable mechanical apparatus. Machine system 10 may also include a cryogenic fluid system 52, in the illustrated case mounted upon a tender car 50 that is coupled with and towed by machine 12, having details and features further discussed herein. As will be further apparent from the following description, features and operating capabilities of cryogenic fluid system 52 are considered to provide various advantages over conventional machine systems in the rail context, and elsewhere. Cryogenic fluid system 52 may be or include a fuel system of machine system 10, for fueling engine 18 to propel machine 12 and any associated rail cars or the like, and provide operational power for machine system 10 generally. In other contexts, cryogenic fluid system 52 could be used in a marine application or a stationary application, such as for operating a stationary genset, a pump, a compressor, or in various manufacturing or industrial settings that are altogether different from electric power generation.

Machine system 10 may further include a glycol system 22 including heating and fuel supply components in the nature of a pump 24, a heat exchanger or radiator 26 and an expansion tank 28, that operate to circulate glycol or another heat exchange fluid to a vaporizer 44 for vaporizing stored cryogenic fluid pumped from cryogenic storage vessel 54. A main fuel flow 32 from fuel conduit 40 to engine 18 is also shown. Fluid coupling hardware 34, including fuel conduit 40 and a glycol conduit 38, extends between machine 12 and tender car 50 in a generally conventional manner. An electrical conduit 36 likewise extends between machine 12 and tender car 50. Mounted upon tender car 50 is vaporizer 44, coupled by an outlet conduit 48 to a cryogenic fluid outlet 56 of a cryogenic fluid storage vessel 54 of cryogenic fluid system 52. From vaporizer 44 cryogenic fluid, such as cryogenic fuel, can be converted to a gaseous state and fed to or past an accumulator 46 that in turn is fluidly coupled by way of fluid coupling hardware 34 to provide fuel flow 32 to engine 18. In the illustrated embodiment, cryogenic fluid system 52 further includes a cap or closure 59 that seals a cold well 58 formed in cryogenic fluid storage vessel 54. A pumping system 60 is positioned within cryogenic fluid storage vessel 54 and can include some components inside cold well 58 in certain embodiments, or outside of cold well 58 in others, as further described herein. Service personnel can access pumping system 60 by way of closure 59, or another service access location depending upon the particular design employed.

Pumping system 60 may further include a first pumping mechanism 68 and a second pumping mechanism 70 including a pump 71. Pumping mechanism 68 may include a low-pressure pumping mechanism structured to transition stored cryogenic fluid from an interior volume 65 of cryogenic fluid storage vessel 54 to pumping mechanism 70, which serves as a high-pressure pumping mechanism. Pumping system 60 may further include a pump housing 75 having a pumping inlet 72 fluidly connected or capable of connection with interior volume 65. Housing 66 may further include a pumping outlet 74 structured to fluidly connect with cryogenic fluid outlet 56, and a pumping chamber (not numbered in FIG. 1) fluidly between pumping inlet 72 and pumping outlet 74. Pumping system 60 also includes a reciprocable pumping element 78 movable within pump housing 76 to transition cryogenic fluid from pumping inlet 72 to pumping outlet 74.

As can be seen in FIG. 1, pump 71 is positioned inside cryogenic storage vessel 54, and reciprocable pump element 78 is movable in a first direction to receive stored cryogenic fluid into pump housing 73, and in a second direction to discharge stored cryogenic fluid from pump housing 73. Pumping mechanism 70 also includes a drive mechanism 80 for actuating reciprocable pumping element 78. Drive mechanism 80 includes a rotatable driving element 82 positioned outside cryogenic storage vessel 54, a rotatable driven element 84 positioned inside cryogenic storage vessel 54, and a magnetic coupling 86 structured to transfer torque between rotatable driving element 82 and rotatable driven element 84. Each of rotatable driving element 82 and rotatable driving element 84 can include a driveshaft or the like. The present disclosure is not thereby limited, however, and one or both of rotatable driving element 82 and rotatable driven element 84 could be or include a gear, belt, wheel, or still another rotatable element. In a practical implementation strategy, rotatable driving element 82 is coupled with an electric motor 88. In alternative embodiments, rather than electric motor 88 a hydraulic motor might be used, or rotatable driving element 82 might be directly driven from an engine gear train or a power takeoff

Drive mechanism 80 further includes a rotary to linear motion converter 90 coupled between rotatable driven element 84 and reciprocable pumping element 78 to apply a linear force to reciprocable pumping element 78 in response to torque applied to rotatable driven element 84 by magnetic coupling 86. In the illustrated embodiment, magnetic coupling 86 may be mounted in or on closure 59 for cryogenic fluid storage vessel 54. In phantom lines cold well 58 formed in cryogenic storage vessel 54 is also depicted in FIG. 1. Embodiments are contemplated where magnetic coupling 86 is formed in other parts of cryogenic storage vessel 54 than a closure, cap, lid or the like. Closure 59 might therefore provide for removal of part or all of pumping mechanism 70 by way of a service port or the like, whether or not magnetic coupling 86 is associated with a cold well. It should regardless be appreciated that no particular limitation to the positioning of magnetic coupling 86, or other parts of pumping mechanism 70 is intended by way of the present description. From FIG. 1 it can also be seen that pumping mechanism 68 can be positioned to supply stored cryogenic fluid to pumping inlet 72 in pump housing 73, and a fluid conduit 77 structured to feed pumped cryogenic fluid from pumping outlet 74 to cryogenic fluid outlet 56, and thenceforth to vaporizer 48 and ultimately to engine 18 or another machine is provided.

It will be appreciated that use of a magnetic coupling, such as a permanent magnet magnetic coupling, avoids any need to breach a wall of cryogenic storage vessel 54. Where magnetic coupling 86 is within a closure, existing designs for robustly sealing a closure to a main portion of a cryogenic storage vessel are readily available. Referring also now to FIG. 2, there are shown additional details of pumping mechanism 70. FIG. 2 illustrates diagrammatically magnetic coupling 86 as it might appear structured so that a first magnetic element 87 is positioned outside of cryogenic storage vessel 54 and on an exterior side of a vessel wall 66. It can be seen from the FIG. 2 illustration that vessel wall 66 can include a double wall, with insulation 67 or empty vacuum space within the double wall structure. Magnetic coupling 86 may also include a second magnetic element 89 positioned on an interior side of vessel wall 66, and spaced an air gap distance from contact with magnetic element 87. It will be appreciated that magnetic fields link rotation of magnetic element 87 with rotation of magnetic element 89, and vice versa. Magnetic element 87 may include a plurality of permanent magnets, and is fixed to rotate with rotatable driving element 82, whereas magnetic element 89 may also include a plurality of permanent magnets, and is fixed to rotate with rotatable driven element 84. In a practical implementation strategy, rotatable driving element 82 and rotatable driven element 84 may be fixed to rotate together by way of magnetic coupling 86 at a ratio of 1:1, however, the present disclosure is not thereby limited. Electric motor 88 may be driven by way of electrical power produced via machine 12, and supplied by way of electrical conduit 36 to motor 88 upon tender car 50.

FIG. 2 also includes additional details respecting pump 71, and rotary to linear motion converter 90, which may be integral with pump 71, but could also be provided as a separate component. In a practical implementation strategy, rotary to linear motion converter 90 includes a driving surface 92 fixed to rotate with rotatable driven element 84 and defining an axis of rotation 100. Rotary to linear motion converter 90 may also include a driven surface 94 fixed to reciprocate with reciprocable pumping element 78 and in contact with driving surface 92. Driven surface 94 may slide in contact with driving surface 92, which may be oriented transverse to axis of rotation 100. Reciprocable pumping element 78 defines an axis of reciprocation 200 that is parallel to axis of rotation 100. Those skilled in the art will appreciate that pump 71 may be a swash plate pump as depicted in FIG. 2, with driving surface 92 including a surface of a swash plate 96 in pump 71. A follower pan assembly 98 may include driven surface 94 and be coupled between swash plate 96 and pumping element 78. It will of course also be appreciated that pump 71 may include a plurality of reciprocable pumping element 78, reciprocating in a plurality of different stages or phases of an operating cycle relative to the other pumping elements 78, and structured to increase a pressure of pumped fluid successively and in a staged manner. In the illustrated embodiment, the interior side of vessel wall 66, upon which magnetic element 89 and pump 71 are located, is exposed to fluid storage volume 65 of cryogenic fluid storage vessel 54. In other embodiments, a different configuration might be used, such as where the interior side of vessel wall 66 in the vicinity of magnetic coupling 86 is exposed to a cold well or other structure or cavity within cryogenic fluid storage vessel 54.

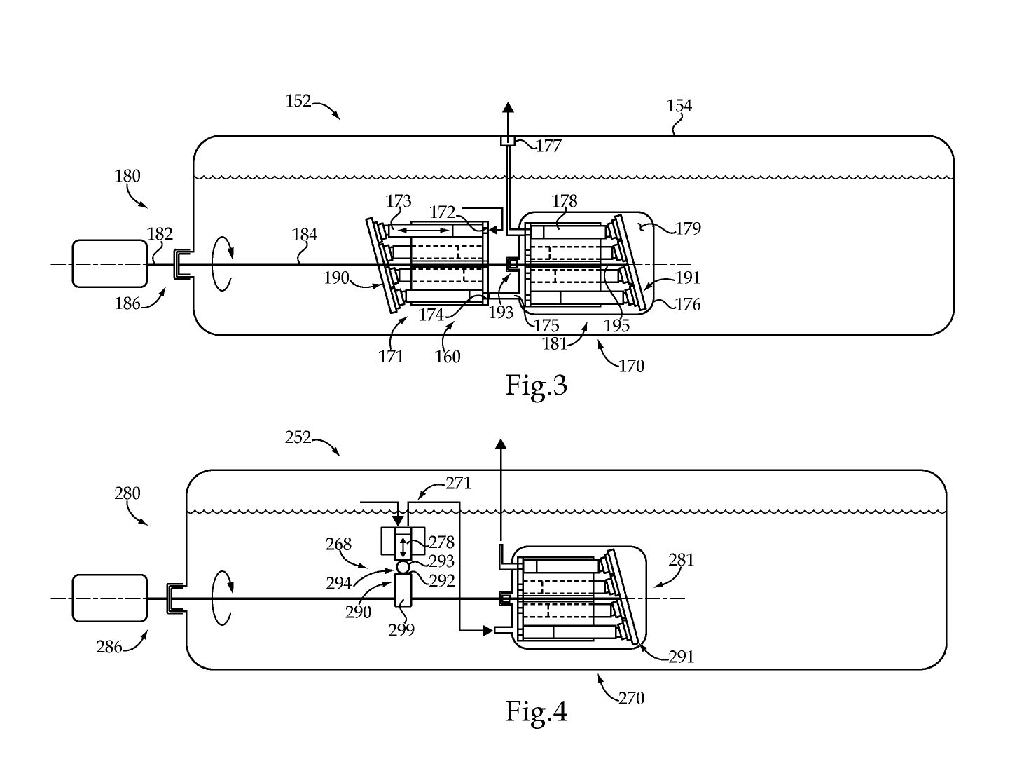

Referring now to FIG. 3, there is shown another cryogenic fluid system 152, and according to another embodiment. Cryogenic fluid system 152 includes a cryogenic fluid storage vessel 154, having a pumping system 160 coupled therewith. Pumping system 160 includes a pumping mechanism 170 having a first pump 171 and a second pump 181, and a drive mechanism 180 including a rotatable driving element 182, a rotatable driven element 184, and a magnetic coupling 186 generally analogous in configuration to that of the embodiments described above but where both of pumps 171 and 181 are operated by way of rotation of rotatable driven element 184. In the illustrated embodiment, second pump 181 includes a reciprocable pumping element 178, or plurality thereof. Pumping mechanism 170 includes a first rotary to linear motion converter 190 and a second rotary to linear motion converter 191 coupled with or part of pumps 171 and 181, respectively. Each of rotary to linear motion converters 190 and 191 can be understood to be coupled between rotatable driven element 184 and the one or plurality of reciprocable pumping elements in each of pumps 171 and 181. It will be noted from FIG. 3 that each of pumps 171 and 181 is illustrated as a swash plate pump. Pumps 171 and 181 may be staged, so that stored cryogenic fluid within cryogenic fluid storage vessel 154 is elevated in pressure from a storage pressure to a first relative extent by pump 171, and to a second relative extent by pump 181. The relative pressure increase provided by each of pumps 171 and 181 can be similar or different, depending on the application. First pump 171 may include a pumping outlet 174 formed in a pump housing (not numbered), and second pump 181 may have formed therein a pumping inlet 175 fluidly connected to pumping outlet 174. In the illustrated embodiment, second pump 181 is positioned within a casing 176 defining an interior volume 179, so that pump 181 can be fluidly isolated from stored cryogenic fluid and the ambient environment within cryogenic storage vessel 154. Pump 181 thus receives fluid increased in pressure by pump 171, and further increases the pressure of the fluid, prior to discharging the fluid out of a cryogenic fluid outlet 177 in cryogenic storage vessel 154.

As shown in FIG. 3, pumps 171 and 181 have opposite orientations with respect to positioning of their swash plates, although the present disclosure is not thereby limited. It can also be noted from FIG. 3 that a rotatable driven element 195 that is part of or coupled with rotatable driven element 184 extends through pump 181. Rotatable driven element 195 may be coupled with pump 171 by way of a coupling 193. Coupling 193 could include a clutch, a speed reduction or a speed increasing gearbox, or some combination of these or other components such that operation of pump 171 is not strictly coupled with operation of pump 181. It will further be appreciated that in contrast to the in-line and generally coaxial configuration of pumps 171 and 181 depicted in FIG. 3, embodiments are contemplated where multiple pumps are not coaxial with one another. In still other instances more than two pumps might be driven from a single magnetic coupling input.

Referring now to FIG. 4, there is shown a cryogenic fluid system 252 according to yet another embodiment, and including a pumping mechanism 270 that includes a first pump 271 and a second pump 281. Cryogenic fluid system 252 may have certain similarities with the foregoing embodiments, but certain differences. Second pump 281, or for that matter first pump 271, may be a swash plate pump, whereas the other of second pump 281 and first pump 271 may include a conventional piston pump, an impeller pump, or still another type of pump that is different from the other pump. An electric drive mechanism 280 provides power to pumps 271 and 281 by way of a magnetic coupling 286. First pump 271 includes a reciprocable pumping element 278, that moves in alternating directions to pump stored fluid to second pump 281. In other embodiments, rather than a staged configuration, where one pump feeds pumped fluid to the other pump, two pumps could feed a cryogenic fluid outlet in parallel, or feed separate cryogenic fluid outlets from a cryogenic storage vessel. Pump 271 may be operated by way of a first rotary to linear motion converter 290, whereas pump 281 may be operated by way of a second rotary to linear motion converter 291. Rotary to linear motion converter 290 may include a cam 299 that rotates in response to torque provided by magnetic coupling 286, such that a driving surface 292 on cam 299 rotates in contact with a driven surface 293 of a cam follower 294 that in turn applies linear force to pumping element 278. From the foregoing description, it will be appreciated that a variety of rotary to linear motion converters are contemplated within the context of the present disclosure, including swash plates where a driving surface is oriented transverse to an axis of rotation of various parts of a drive mechanism, as well as versions where a driving surface, such as surface 292 in the FIG. 4 embodiment, is oriented generally parallel to an axis of rotation. Still other configurations are contemplated within the context of the present disclosure.

### INDUSTRIAL APPLICABILITY

Referring to the drawings generally, but in particular to FIG. 2, pump 71 is shown as it might appear where the topmost one of pumping elements 78 has just completed an intake stroke to draw stored cryogenic fluid through pumping inlet 72 and into pumping chamber 76. Swash plate 96 is rotating in response torque applied to magnetic element 89 from magnetic element 87, in turn rotated by way of the electric motor 88 and rotatable driving element 82. Other reciprocable pumping elements in pump 71 are phased differently from the topmost reciprocable pumping element 78, and are therefore potentially at other various stages of fluid intake or pressurization. Transferring torque magnetically from rotatable driving element 82 to rotatable driven element 84 enables pump 71, and other pumping system embodiments discussed and contemplated herein, to be driven without the need for a rotating driveshaft to penetrate through vessel wall 66. Those skilled in the art will appreciate the advantages associated with avoiding the relatively complex, expensive and necessarily periodically serviced seals that are required where shaft penetration is employed. The transferred torque may be converted to linear force on pumping element 78, as swash plate 96 continues its rotation, bringing driving surface 92 to bear against driven surface 94 and urge pumping element 78 to the right in FIG. 2 to commence and eventually complete a pumping or pressurization stroke.

Other embodiments discussed above where multiple pumps are used can be expected to operate generally in an analogous manner, with the exception of the cryogenic fluid being pumped out of a cryogenic storage vessel only after being subjected to multiple pressurization stages. Once pumped out of a cryogenic storage vessel, the pumped fluid can be employed for various uses including but not limited to fueling an internal combustion or other type of combustion engine. Cryogenic fluid hydrocarbon fuel may be vaporized by way of vaporizer 44 and conveyed in a gaseous form to engine 18. Those skilled in the art will further be familiar with known strategies for operating a pump by way of a magnetic coupling. The present disclosure is contemplated to improve over such strategies, however, as converting of rotary force to linear force enables greater pressurization than is typically available with rotating impeller pumps and the like which tend to be subject to performance limiting cavitation and have other shortcomings. Where multiple rotary to linear motion converters are used to drive multiple pumps, the improvements can be magnified by way of the availability of multiple pressurization stages.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims.

What is claimed is:

1. A machine system comprising:
a machine;
a cryogenic fluid system including a cryogenic storage vessel, and a pumping mechanism structured to pump stored cryogenic fluid from the cryogenic storage vessel for supplying to the machine;
the pumping mechanism including a pump positioned inside the cryogenic storage vessel and having a pump housing, a reciprocable pumping element movable in a first direction to receive stored cryogenic fluid into the pump housing and in a second direction to discharge stored cryogenic fluid from the pump housing, and a drive mechanism for actuating the reciprocable pumping element;
the drive mechanism including a rotatable driving element positioned outside the cryogenic storage vessel, a rotatable driven element positioned inside the cryogenic storage vessel, and a magnetic coupling structured to transfer torque between the rotatable driving element and the rotatable driven element; and
the drive mechanism further including a rotary to linear motion converter coupled between the rotatable driven element and the reciprocable pumping element to apply a linear force to the reciprocable pumping element in response to torque applied to the rotatable driven element by the magnetic coupling.

2. The system of claim 1 wherein the rotary to linear motion converter includes a driving surface fixed to rotate with the rotatable driven element and defining an axis of rotation, and a driven surface fixed to reciprocate with the reciprocable pumping element and in contact with the driving surface.

3. The system of claim 2 wherein the driving surface is oriented transverse to the axis of rotation, and the reciprocable pumping element defines an axis of reciprocation that is parallel to the axis of rotation.

4. The system of claim 3 wherein the pump includes a swash plate pump and the driving surface includes a surface of the swash plate in the swash plate pump.

5. The system of claim 1 wherein the cryogenic fluid storage vessel includes a vessel wall, and the magnetic coupling includes a plurality of magnets positioned on each of an interior side and an opposite exterior side of the vessel wall.

6. The system of claim 5 wherein the interior side of the vessel wall is exposed to a fluid storage volume of the cryogenic fluid storage vessel.

7. The system of claim 5 wherein the vessel wall includes a closure to a port formed in the cryogenic fluid storage vessel.

8. The system of claim 1 wherein the pumping mechanism includes a second pump positioned inside the cryogenic fluid storage vessel and coupled with the drive mechanism.

9. The system of claim 8 wherein the second pump includes a second reciprocable pumping element, and wherein the pumping mechanism includes a second rotary to linear motion converter coupled between the rotatable driven element and the second reciprocable pumping element.

10. The system of claim 9 wherein the first pump includes a pumping outlet formed in the pump housing, and the second pump includes a second pump housing having formed therein a pumping inlet fluidly connected to the pumping outlet of the first pump.

11. The system of claim 1 wherein the machine includes a combustion engine and the cryogenic fluid system includes a fuel system, and wherein the fuel system includes a fluid conduit coupling the pumping mechanism with the combustion engine, and a vaporizer fluidly coupled with the fluid conduit.

12. A cryogenic fluid system comprising:
a pumping mechanism including a pump having a pump housing, a reciprocable pumping element movable in a first direction to receive stored cryogenic fluid into the pump housing and in a second direction to discharge stored cryogenic fluid from the pump housing;
a cryogenic storage vessel wall;
a drive mechanism including a rotatable driving element, a rotatable driven element, and a magnetic coupling structured to transfer torque between the rotatable driving element and the rotatable driven element; and
the magnetic coupling including a first magnetic element fixed to rotate with the rotatable driving element and positioned upon an exterior side of the cryogenic storage vessel wall, a second magnetic element fixed to rotate with the rotatable driven element and positioned upon an interior side of the cryogenic storage vessel wall;
the drive mechanism further including a rotary to linear motion converter coupled between the rotatable driving element and the reciprocable pumping element to apply a linear force to the reciprocable pumping element in response to torque applied to the rotatable driving element by the magnetic coupling.

13. The system of claim 12 wherein the pumping mechanism further includes a second pump positioned on the interior side of the cryogenic storage vessel wall and coupled with the drive mechanism.

14. The system of claim 13 wherein the second pump includes a second reciprocable pumping element, and a second rotary to linear motion converter to apply a linear force to the second reciprocable pumping element in response to torque applied to the rotatable driving element by the magnetic coupling.

15. The system of claim 13 wherein the first pump includes a pumping outlet, and the second pump includes a pumping inlet fluidly connected to the pumping outlet.

16. The system of claim 15 wherein the first pump includes a first swash plate pump having a first swash plate, and the second pump includes a second swash plate pump having a second swash plate, and the first swash plate and the second swash plate are rotatable by way of the rotatable driven element about a common axis of rotation.

17. The system of claim 16 wherein the rotatable driven element extends through the first swash plate pump.

18. A method of operating a cryogenic fluid system comprising:
rotating a driving element positioned outside a cryogenic fluid storage vessel;
transferring torque magnetically from the driving element to a driven element positioned inside the cryogenic fluid storage vessel;
converting torque of the driven element to linear force on a pumping element in a pump at least partially submerged in cryogenic fluid within the cryogenic storage vessel; and
pumping the cryogenic fluid out of the cryogenic storage vessel at least in part by way of a reciprocation of the pumping element in response to the linear force.

19. The method of claim 18 wherein the pumping of the cryogenic fluid further includes pumping the cryogenic fluid to a first pressurized state by way of the first pump, and further comprising pumping the cryogenic fluid to a second pressurized state that is higher than the first pressurized state by way of a second pump at least partially submerged in cryogenic fluid within the cryogenic fluid storage vessel and coupled with the driven element.

20. The method of claim 19 wherein the cryogenic fluid includes cryogenic fluid hydrocarbon fuel, and further comprising vaporizing at least a portion of the hydrocarbon fuel in a vaporizer and conveying the hydrocarbon fuel to a combustion engine.
